(19) United States
(12) Patent Application Publication
(10) Pub. No.: US 2010/0055248 A1
(43) Pub. Date: Mar. 4, 2010

(54) PRODUCTS CONTAINING POLYPHENOLS

(75) Inventors: Keith A. Woelfel, Sparta, NJ (US); Rebecca J. Robbins, Budd Lake, NJ (US)

Correspondence Address: GIBBONS P.C., ONE GATEWAY CENTER, NEWARK, NJ, 07102, US

(73) Assignee: Mars, Inc., Mclean, VA (US)

(21) Appl. No.: 12/305,247

(22) PCT Filed: Jun. 28, 2006
(86) PCT No.: PCT/US2006/025494

§ 371 Date: Dec. 17, 2008

Related U.S. Application Data
(60) Provisional application No. 60/695,361, filed on Jun. 29, 2005.

(30) Foreign Application Priority Data
Jun. 29, 2005 (US) 11170593

(51) Int. Cl. A23C 9/152; A23L 2/38; A23L 2/46; A23L 2/52; A23C 3/02; A23C 9/154; A23C 9/156; A23C 9/158; A23C 21/00

(52) U.S. Cl. 426/72; 426/580; 426/583; 426/598; 426/593; 426/74; 426/548; 426/575; 426/578; 426/330.2; 426/330.3; 426/324

(57) ABSTRACT

Shelf-stable products, particularly beverages, containing polyphenols and optionally sterol and/or stanol esters are disclosed. Loss of polyphenols during the heat processing of the products is prevented by reducing the pH of the product by at least 0.2 after mixing and prior to heat processing. The pH of the final beverage should be about pH 4.6 to about pH 6.8. The preferred products are low fat cocoa beverages containing at least 0.2-5 micrograms of cocoa polyphenols per gram of the beverage.

### CROSS REFERENCE TO RELATED APPLICATIONS

This application is a PCT application which claims priority to provisional application Ser. No. 60/695,361 filed Jun. 29, 2005 for “Formulations for Vascular Health” and utility application Ser. No. 11/170,593 filed Jun. 29, 2005 for “Process for Controlling the Isomerization of (−)-Epicatechin and (+)-Catechin in Edible Food Products”.

### FIELD OF THE INVENTION

The inventions relate to products, particularly beverages, containing polyphenols and optionally sterol and/or stanol esters and processes for producing them. The products prepared by the inventive process have conserved levels of polyphenols.

### BACKGROUND OF THE INVENTION

Polyphenolic compounds are bioactive substances that are derived from plant materials. They are closely associated with the sensory and nutritional quality of products derived from the plant materials. Many plant polyphenols have an antioxidant activity. Consumption of the polyphenols present in tea, red wine, and cocoa provides significant health benefits.

Standard aseptic processing techniques for making ready-to-eat or ready-to-drink products result in losses of polyphenols such as flavan-3-ols and proanthocyanidins.

Accordingly, it would be highly desirable to prepare ready-to-eat or ready-to-drink products, especially milk-based beverages, where the polyphenols are not lost, but conserved, during the heat processing required to prepare the final product and to produce a shelf stable product. Heat processing milk-based beverages at a neutral or near neutral pH is a particular concern because cooking for the time required to sterilize the beverage can cause denaturation of the milk proteins.

### BRIEF SUMMARY OF THE INVENTION

Heat-processed, ready-to-eat or ready-to-drink products containing at least about 0.2 micrograms of polyphenols per gram of the product are prepared. The amount of polyphenols is preferably about 0.2 to about 5. The products have a moisture content of at least about 5 weight %. When the product is a beverage, the moisture content is about 50% to about 80%. The pH of the final product is about 4.8 to about 6.8, preferably about 6.2 to about 6.8. The polyphenols are edible flavan-3-ols, e.g., catechin, epicatechin, gallocatechin, epigallocatechin, and/or afzelechin, and/or edible proanthocyanidins, e.g., procyanidins, prodelphinidins, and/or propelargonidins.

Preferred products include milk-based, soy-based, and whey-based cocoa beverages containing cocoa polyphenols such as (±)-catechin, (±)-epicatechin, and/or procyanidin oligomers thereof. In the cocoa beverages, one or more high CP cocoa ingredients are used including partially defatted cocoa powder, fully defatted cocoa powder, chocolate liquor, liquid cocoa extract and/or dry cocoa extract.

The partially cocoa powder contains at least about 25 milligrams, preferably about 25 to 35 milligrams, of cocoa polyphenols per gram of the defatted cocoa powder. The chocolate liquor contains about 12 milligrams, preferably about 13 to 17 milligrams, of cocoa polyphenols per gram of the defatted liquor. The cocoa extracts contain at least about 200 milligrams, preferably about 350 to 500 milligrams, of cocoa polyphenols per gram of the dry extract.

The pH is adjusted with edible acid such as citric acid or an edible base such as sodium hydroxide.

An improved process for preparing ready-to-eat or ready-to-drink products containing polyphenols comprises the step of reducing the pH of the product after mixing and before heat processing by at least 0.2, preferably 0.4. Typically, pH is below about 7.5, preferably to about 4.6 to about 6.8 before heat processing.

A process for preparing a ready-to-drink cocoa beverage containing one or more procyanidins comprises the steps of adding the procyanidin(s) to the beverage; lowering the pH of the beverage by at least 0.2 to about 4.6 to about 6.8, with an edible acid; heat-processing the pH adjusted beverage; and packaging the heat-processed beverage. The heat-processing is carried out at about 145° F. to about 280° F. for about 1 second to about 15 seconds.

A process for preparing a cocoa beverage containing at least about 0.2 micrograms of cocoa polyphenols per gram of the beverage comprises the steps of slurrying, under high shear, water and a dry cocoa mixture comprising one or more cocoa ingredients; mixing a dry blend consisting essentially of a sweetener, one or more thickeners, one of more stabilizers, and a vitamin-mineral mixture into milk; adding the cocoa slurry to the milk mixture; and adding liquid flavorants. An edible acid or an edible base is used to adjust the pH from about 6.8 to about 7.5, preferably about 6.8 to about 7.2, more preferably about 6.9 to about 7 to about 4.6 to about 6.8, preferably about 6.2 to about 6.8. The slurry is heat processed for about 1 second to about 15 seconds at about 161° F. to about 280° F. Optionally, the slurry is cooled and/or homogenized prior to packaging. Typically, the beverages have a moisture content of about 50%. Preferably, the cocoa ingredients are prepared from unfermented and/or underfermented cocoa beans. The cocoa extracts are prepared by solvent extracting defatted, unfermented or underfermented cocoa beans and removing the solvent. The beverages also contain an alkalized cocoa powder, an emulsifier (e.g., lecithin), a sweetener (e.g., sugar), one or more thickeners, one or more stabilizers, a vitamin-mineral mixture, and/or one or more flavorants. The loss of (−)-epicatechin and (+)-catechin during the heat-processing of a polyphenol-containing product having a water content of at least about 50 weight % is minimized by lowering the pH of the product at least 0.2, typically to a pH of about 4.6 to about 6.8 prior to the heat-processing. After the heat-processing, the cocoa polyphenols present in the beverages comprise (+)-epicatechin, (−)-epicatechin, (+)-catechin, (−)-catechin, and procyanidin dimers and trimers thereof.

Preferably, the cocoa beverages contain heart healthy vitamins such as B6 and B12, antioxidants such as vitamins E and C, and/or minerals such as calcium. In a preferred embodiment the products contain plant sterol and/or stanol esters. The amount of the sterol and/or stanol esters is about 0.1 to about 30 micrograms per gram of the product. For maximum benefit, the products should be used as part of a diet that is low in saturated fat and cholesterol.

### BRIEF DESCRIPTION OF THE FIGURES

FIG. 1 is a schematic showing how the product is thermally processed. Typical ingredients are combined, mixed, and pH-standardized before the final sterilization and packaging processes. S1 through S5 are sampling points where the total cocoa polyphenol (CP) content is measured during the production process.

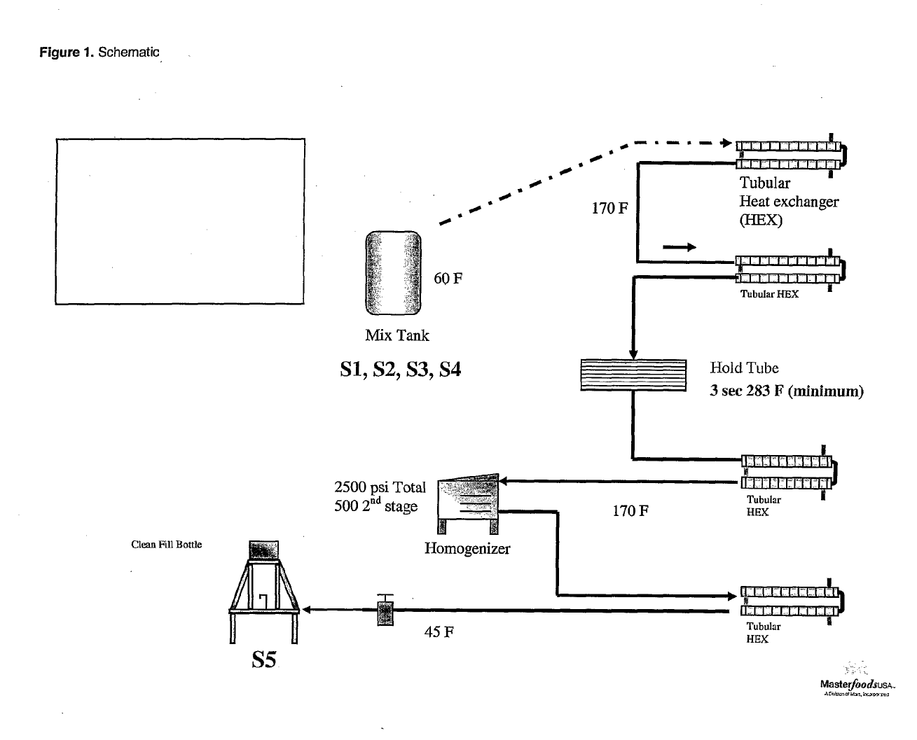

FIG. 2 is a schematic describing the aseptic processing of a typical high CP, milk-based beverage. The initial slurrying of the high CP cocoa powder, the dried high CP cocoa extract, alkalized cocoa powder, is carried out at 60° C. (180° F.) under high shear to hydrate the cocoa and completely disperse all dry ingredients with the cocoa powder. The mixture is pH adjusted, preferably to 6.5 or less by the addition of citric acid. It is important to note that the pH adjustment is done prior to thermal processing, to the complete, unprocessed batch. The beverage is then sterilized and packaged.

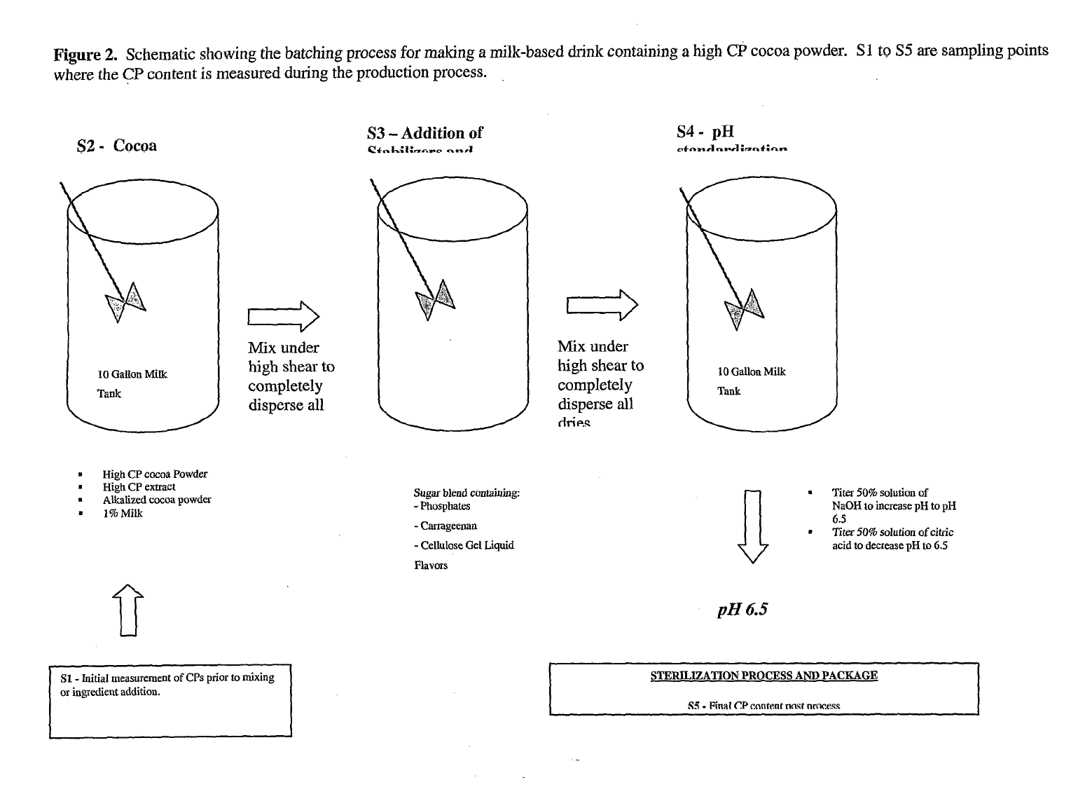

FIG. 3 is the normal phase HPLC/FLD trace for the high CP cocoa powder.

FIG. 4 is the normal phase HPLC/FLD trace for the high CP cocoa extract.

FIG. 5 is the normal phase HPLC/FLD trace for the cooked high CP cocoa extract.

FIGS. 6A and 6B are HPLC/FLD traces for the high CP cocoa beverage before and after UHT heat processing.

### DETAILED DESCRIPTION OF THE INVENTION

As used herein, a “food” is a material containing protein, carbohydrate and/or fat, which is used in the body of any organism to sustain growth, repair vital processes, and to furnish energy. Foods may also contain supplementary substances, such as minerals, vitamins, and condiments (Merriam-Webster Collegiate Dictionary, 10th Edition, 1993). The term “food” includes a beverage adapted for human or animal consumption. A “food additive” is defined by the FDA in 21 C.F.R. 170.3(e)(1) and includes direct and indirect additives.

As used herein, “dietary supplement” is a product (other than tobacco) that is intended to supplement the diet and that bears or contains one or more of the following dietary ingredients: a vitamin, a mineral, an herb or other botanical, an amino acid, a dietary substance for use by man to supplement the diet by increasing the total daily intake, or a concentrate, metabolite, constituent, extract or combination of these ingredients. (Merriam-Webster Collegiate Dictionary, 10th Edition, 1993). When the term is used on food labels, “supplement” means that nutrients have been added in amounts greater than 50% above the U.S. Recommended Daily Allowance (“Understanding Normal and Clinical Nutrition”, 3d Edition, Editors Whitney, Catalado and Rolfes at page 525).

The present invention relates to moisture-containing products, particularly beverages, which contain flavan-3-ols such as catechin, epicatechin, gallocatechin, epigallocatechin and/or afzelechin, and proanthocyanidins such as procyanidins, prodelphinidins, and propelargodins, which in a preferred embodiment are used in combination with sterol ester(s) and/or stanol ester(s).

Cholesterol-lowering agents other than sterol/stanol esters may be used herein in combination with the sterol ester(s) and/or stanol ester(s). Examples include low calorie and non-caloric fats.

The products may contain L-arginine, minerals such as calcium, potassium and magnesium, vitamins such as B, C, and E, a carotenoid, and mono- or polyunsaturated fatty acids (e.g., an omega-3 fatty acid). Polyphenols from sources other than cocoa, which have antioxidant properties similar to those of the cocoa procyanidins, may also be used alone or in combination with the cocoa procyanidins. These include nuts, nut flours, and nut skins.

As used herein, the term “cocoa polyphenols” refers to the polyphenolic compounds present in cocoa beans, cocoa nibs, and cocoa ingredients prepared from cocoa beans or nibs, such as partially or fully defatted cocoa powder, chocolate liquor, and liquid or dry cocoa extracts.

The term “procyanidin” refers to naturally occurring or synthetically derived oligomers of catechin and/or epicatechin; however, any reference to “cocoa procyanidins” herein should be understood to also include the monomers (±)-catechin and (±)-epicatechin. (+)-Catechin, (−)-epicatechin, and their respective epimers (−)-catechin and (+)-epicatechin have the structure shown below:

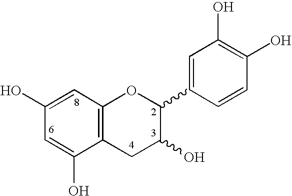

Procyanidin oligomers may have from 2 to about 18 monomeric units. The oligomers include, for example, dimers, trimers, tetramers, pentamers, hexamers, heptamers, octamers, nonamers, decamers, etc. In the natural oligomer, the monomers are connected via (4→6) and/or (4→8) interflavan linkages. Oligomers with exclusively (4→8) linkages are linear. The presence of at least one (4→6) linkage results in a branched oligomer. For the synthesis of (4→48) procyanidins, see U.S. Pat. No. 6,420,572, the disclosure of which is incorporated herein by reference, The '572 patent discloses coupling hydroxy-protected phenolic monomers (e.g., epicatechin or catechin) having a C-4 activating group (e.g., a C₂-C₆ alkoxy group having a termimal hydroxy group such as hydroxyethoxy) with a second protected phenolic monomer to prepare protected dimers which are then deprotected or optionally coupled with other protected, activated phenolic monomers.

Cocoa polyphenol derivatives may also be useful herein. These include gallated catechin and/or epicatechin monomers and oligomers, glycosylated monomers and oligomers, and mixtures thereof; metabolites of the procyanidin monomers and oligomers such as sulfated, glucuronidated, and methylated forms; and enzyme cleavage products of procyanidins generated by colonic microflora metabolism or internal mammalian metabolism. The derivatives may be from natural sources or prepared synthetically.

Synthetic oligomers are also useful herein. See U.S. Pat. No. 6,156,912 issued Dec. 5, 2000 to W. Tückmantel et al. and U.S. Pat. No. 6,476,241 issued Nov. 5, 2002 to A. Kozikowski et al.

The term “fair average quality cocoa beans” refers to cocoa beans that have been separated from the pulp material and dried. They are relatively free of mold and infestation. Such beans are a commercial commodity and form the feedstock for preparing high CP cocoa solids and powder, high CP chocolate liquor, and high CP cocoa extracts. The term includes any such bean that has been genetically modified or produced.

The term “raw freshly harvested cocoa beans” refers to freshly harvested beans (also referred to as seeds) from the cocoa pod, which have not been subjected to processing other than separation from the pulp. Cocoa beans from any species of Theobroma, Herrania or inter- and intra-species crosses thereof may be used to prepare the cocoa ingredients, i.e., the cocoa powders, chocolate liquor, and cocoa extracts for use herein. Preferably, the cocoa ingredients are prepared from unfermented and/or underfermented cocoa beans having a fermentation factor of 275 or less. The “fermentation factor” is determined using an industry-recognized grading system. To assess the degree of fermentation, cocoa beans are typically subjected to a standard cut test for assessing quality as defined by standards. Slaty cocoa beans, purple cocoa beans, mixtures of slaty and purple cocoa beans, mixtures of purple and brown cocoa beans, or mixtures of slaty, purple, and brown cocoa beans can be used. More preferably, the cocoa beans are slaty and/or purple cocoa beans since they have higher cocoa polyphenol contents than fermented beans.

### Cocoa Ingredients

As used herein, the term “cocoa powder” refers to partially or fully defatted cocoa powders (e.g., cakes or solids) prepared directly by pressing (e.g., by screw pressing) shelled cocoa beans into cocoa butter and partially defatted cocoa solids or by milling roasted cocoa beans into chocolate liquor and pressing the chocolate liquor to recover cocoa butter and partially defatted cocoa solids.

As used herein, the term “high CP cocoa ingredient” refers to cocoa ingredients in which the flavan-3-ols and procyanidins are conserved during the preparation of the cocoa ingredients and/or to cocoa ingredients prepared from unfermented, underfermented cocoa beans. The high CP cocoa powder contains at least about 25, preferably 25-50, most preferably 25-35 milligrams of cocoa polyphenols per gram of the defatted powder. The high CP chocolate liquor contains at least about 10, preferably about 12 to about 25, most preferably about 13 to about 17 milligrams of cocoa polyphenols per gram of the defatted liquor. The high CP cocoa extract contains at least 200, preferably 250-500, more preferably about 350 to about 500 milligrams of cocoa polyphenols per gram of the dry extract.

A method for preparing cocoa solids having a high cocoa polyphenol content directly from cocoa beans is disclosed in U.S. Pat. No. 6,015,913 issued Jan. 18, 2000 to Kirk S. Kealey et al., the disclosure of which is incorporated herein by reference. In the process of the '913 patent, the cocoa beans are heated for a time and at an internal bean temperature sufficient to loosen the cocoa shell without roasting the cocoa nib (e.g., infra-red heating to about 100° C. to about 110° C.). The method for determining the internal bean temperature (IBT) is described in the '913 patent. The cocoa nibs are winnowed from the cocoa shells. The cocoa nibs are pressed into the cocoa butter and partially defatted cocoa solids. The cocoa solids contain cocoa polyphenols including cocoa procyanidins from the cocoa nibs. Larger amounts of the higher procyanidin oligomers are present in cocoa solids thus produced than are present in cocoa solids prepared by a traditional roasting process. The total cocoa procyanidin content of the cocoa powders and cocoa extracts are determined as described hereafter.

A method for preparing cocoa solids or chocolate liquor from roasted unfermented, underfermented, or fair to average quality cocoa beans is disclosed in U.S. Pat. No. 6,312,753 issued Nov. 6, 2001 to Kirk S. Kealey et al., the disclosure of which is incorporated herein by reference. Cocoa beans or nibs having a fermentation factor of 275 or less are used. The beans are passed through an infra-red heater, and winnowed to separate the shell (hull), roasted to an internal bean temperature of about 95° C. to about 150° C., and milled into a coarse chocolate liquor from which the cocoa butter and partially defatted cocoa solids are pressed.

Preferably, a cocoa extract is included in the products herein, e.g., the cocoa beverage, to increase the total cocoa polyphenol content of the product. The preparation of cocoa extracts from cocoa beans is disclosed in U.S. Pat. No. 5,554,645 issued Sep. 10, 1996 to Leo J. Romanczyk, Jr. et al., the disclosure of which is incorporated herein by reference. In the process of the '645 patent cocoa beans including the pulp are freeze dried, the freeze dried mass is depulped, the freeze dried cocoa beans are dehulled and ground, and the resulting cocoa mass is defatted and then solvent extracted, for example with aqueous methanol, aqueous acetone, or ethyl acetate. Extracts can also be prepared from high CP cocoa solids prepared by the processes described in the '913 and '753 patents previously discussed. Processes for preparing cocoa extracts enriched in certain oligomers, as well as decaffeinated and detheobrominated cocoa extracts, are described in U.S. Pat. No. 6,627,232 issued Sep. 30, 2003 to John F. Hammerstone, et al., the disclosure of which is incorporated herein by reference. Tetramers and higher molecular weight cocoa procyanidin oligomers are obtained when high CP cocoa solids prepared from non-roasted cocoa beans are extracted with ethyl acetate and the extracted solids are extracted again with acetone, ethanol, or mixtures thereof with up to 50% water. The ethyl acetate extract is enriched in the monomers, dimers, and trimers.

Alkalized cocoa powders are added to improve the flavor and color of the beverage. The FDA Standards of Identity for alkalizing cocoa allows the use of a maximum of 3% anhydrous potassium carbonate or its alkaline equivalent based on the roasted nib weight.

### Sterol and/or Stanol Esters

Phytosterols are plant sterols that do not dissolve in water and have a molecular weight and structure similar to cholesterol. Over forty plant sterols have been identified but beta-sitosterol, campesterol and stigmasterol are the most abundant. Other examples of useful sterols are brassicasterol, desmosterol, chalinosterol, poriferasterol, and clionasterol.

Stanols are saturated derivatives of sterols in which all carbon to carbon bonds in the rings are saturated. Stanols typically have 28 or 29 carbon atoms and include beta-sitostanol, clionastanol, 22,23-dyhydrobrassicastanol and campestenol. Stanols are found in small amounts in nature but may be easily prepared from sterols by hydrogenating sterols by any of the several methods known to those skilled in the art. When a sterol starting material is prepared from a plant material it will contain a mixture of several different sterols. Thus, after hydrogenation the resulting stanol will also be a mixture of different stanols.

Esterified forms of sterols and stanols are the preferred forms used herein. Esterification renders the sterols/stanols more soluble in fats and oils. For example, sterols may be esterified with fatty acid esters such as rapeseed oil, Canola oil, and like oils. Suitable fatty acids include saturated or unsaturated fatty acids typically having 14 to 24 carbon atoms. Examples of esterified sterols include sitosterol acetate, sitosterol oleate and stigmasterol oleate. Stanol esters may be prepared as is known in the art as, for example, described in U.S. Pat. No. 6,174,560 issued Jan. 16, 2001 to Miettenen et al. and assigned to Raisio Benecol Ltd.; U.S. Pat. No. 6,031,118 issued Feb. 29, 2000 to van Amerongen et al. and assigned to Lipton; U.S. Pat. No. 5,958,913 issued Sep. 28, 1999 to Miettenen et al. and assigned to Raisio Benecol; U.S. Pat. No. 5,892,068 issued Apr. 6, 1999 to Higgins, III and assigned to McNeil PPC, Inc.; and U.S. Pat. No. 5,502,045 issued Mar. 26, 1996 to Miettenen et al. and assigned to Raisio Benecol, Ltd., the disclosures of which are incorporated herein by reference. The '045 patent describes the interesterification of free stanols with a methyl ester mixture of C₂ to C₂₂ fatty acids (e.g., rapeseed oil) using an interesterification catalyst such as sodium ethylate. An interesterification process such as that disclosed in the '045 patent can also be used to esterify sterols. In another embodiment, useful stanol esters are prepared by esterifying at least one sterol with a C₂ to C₂₂ fatty acid ester as described in the '913 patent cited above.

Particularly useful herein are Canola oil sterol esters, sunflower oil sterol esters, and their mixtures. These sterol ester mixtures melt at around 30°-50° C.; however, typically the esters are heated to about 60°-80° C. to ensure the entire mixture is liquified. The liquid or liquefied (i.e., molten) sterols/stanol esters and the emulsifier are mixed with the cocoa slurry before or after the addition of the milk.

### Emulsifier(s)

Preferably, an emulsifier such as lecithin, a mono- or diglyceride, mono- or diglyceride, a phospholipid, an ester of a monoglyceride and acetic, lactic, citric, succinic, or tartaric acid, a fatty acid ester of a polyglycerol, sorbitol esters, sucrose esters, propylene glycol, or polyglycerol polyresorcinoleate is premixed with the sterol and/or stanol esters or separately added together with the sterol an/or stanol esters to cocoa. The emulsifier is used in amounts of about 0.05% to about 5%, preferably about 0.05% to about 1%, more preferably about 0.05% to about 0.25%. Emulsifying agents are well known to play a critical role in suspension rheology and are used throughout food manufacturing, especially confectionery and chocolate manufacturing, to enhance the rheology (i.e., reduce viscosity and/or yield value) of solids suspensions.

Lecithin derived from vegetable oils, e.g., soybean, cottonseed, corn, safflower, and rapeseed oil, including clarified lecithins, fluidized lecithins, compounded lecithins, hydroxylated lecithins, deoiled lecithins, and fractionated lecithins are useful herein. Soy lecithin is the preferred emulsifier for use herein. It is one of the oldest and most widely used emulsifying agents. It can be used in amounts of up to about 5%, preferably about 0.05% to about 0.3%, more preferably about 0.1% to about 0.3% by weight, based on the finished product. The pH may be adjusted downward via a 50% aqueous citric acid solution (w/w) or be adjusted upward via a 50% aqueous sodium hydroxide solution (w/w).

### Sweeteners

Nutritive carbohydrate sweetener(s) and/or sugar substitute(s) are used herein. Suitable sweeteners include those typically used in foods and include, but are not limited to, sucrose (e.g., from cane or beet), dextrose, fructose, lactose, maltose, glucose syrup solids, corn syrup solids, invert sugar, invert sugar, honey, maple sugar, brown sugar, molasses, and the like. Suitable sugar substitutes may be used to partially replace the nutritive carbohydrate sweetener. The term “sugar substitute” includes high potency sweeteners, sugar alcohols (polyols) and bulking agents, or combinations thereof. The high potency sweeteners include aspartame, cyclamates, saccharin, acesulfame, neo-hesperidin dihydrochalcone, sucralose, alitame, stevia sweeteners, glycyrrhizin, thaumatin, and the like, and mixtures thereof. The preferred high potency sweeteners include aspartame, cyclamates, saccharin, and acesulfame-K. Examples of sugar alcohols may be any of those typically used in the art and include sorbitol, mannitol, xylitol, maltitol, isomalt, lactitol and the like. The food products of the present invention may also contain bulking agents, typically used in combination with high potency sweeteners. The term “bulking agents” as defined herein may be any of those typically used in the art and include polydextrose, cellulose and its derivatives, maltodextrin, gum arabic, and the like.

### Other Ingredients

Minor amounts of other water-soluble or water-dispersible ingredients are also included in the beverage, for example up to about 35% of thickeners, preferably about 0.01 to about 5%, up to ______% of stabilizers, preferably about 0.2 to about 3%, up to 1.0% of vitamins and/or minerals, preferably about 0.01 to about 0.35%, up to 1% of a flavorant, and up to 0.5% of a salt.

### Stabilizers

Phosphates are used as protein stabilizers. They protect the protein, e.g., the protein in the milk, from graining due to heat and acid shock. Under vigorous thermal conditions, such as those used in aseptic processing, milk proteins are more stable at a neutral pH.

Another method for stabilizing proteins is a heating pre-treatment step. The liquid containing the proteins is pre-heated to around 160-180° F. to increase their stability against the thermal shock during sterilization. The pre-treatment steps follows the whey-proteins to unfold and partially denature, thus decreasing the chance of graining during aseptic processing.

Gums such as carrogeenan are often used in ppm levels to suspend cocoa solids in milk beverages. Micro-crystalline cellulose is also used in the cocoa beverage to build mouthfeel. It works synergistically with the carrogeenan to suspend the cocoa powder.

As used herein, the term “flavoring agent” refers to flavored compounds or compositions used in foods and beverages to impart a desired taste and/or aroma. Exemplary flavoring agents suitable for use herein include vanillin, chocolate, fruits such as blueberry, raspberry, strawberry, and banana, spices, and naturally expressed citrus or spice oils.

### Heat Processing

The products may be heat-processed by vat pasteurization which requires heating at about 63° C. (145° F.) for about 30 minutes, by high temperature, short time pasteurization (HTST) which requires heating at about 89° C. (191° F.) for about 1.0 second, or by ultra-high temperature sterilization (UHT) which requires heating at about 138° C. (280° F.) for about 2 seconds.

### pH Adjustment

In most products the pH is reduced by at least 0.2, preferably about 0.4, most preferably to 0.6. The pH of the product prior to heat processing should be about 6.8 to about 7.5, preferably about 6.8 to about 7.3, or most preferably about 6.9 to about 7.2. When the pH is adjusted from 7.2 to 6.5, the CP loss is reduced up to 30%. When the pH is adjusted from 6.8 to 6.2, the retention of polyphenols is improved by about 16%. Prior to thermal processing, the overall loss is only about 20%. After the thermal processing, the overall loss increases to about 35%.

In addition to conserving cocoa polyphenols, the pH adjustment provides a process for improving the flavor and/or reducing the bitter and astringent flavors typically associated with polyphenols.

### Test Methods

Percentage of CP losses are calculated by subtracting the final CP amount from the starting CP amount and dividing by the starting CP amount, and multiplying by 100.

### Determination of Total Cocoa Procyanidin Content

The total cocoa polyphenol content of the powders, cocoa extracts, and beverages was determined by normal phase high pressure liquid chromatography (HPLC) on silica with fluorescent detection. The details of this approach are covered in Adamson, et al., J. Ag. Food Chem. 47 (10) 4184-4188 (1999). Cocoa solids were defatted with hexane prior to extraction of the procyanidins. The hexane was discarded and the solids were extracted with acetone. A total of 32-35 g of the cocoa beverage was quantitively transferred to a 100 mL volumetric flask. To this was added 0.5 mL of glacial acetic acid and the solution was brought to volume with acetone. This solution was comparable to the extraction solvent used for all the other samples which consisted of 70:29.5:0.5 acetone:water:acetic acid [v/v/v]. Beverage samples were not defatted prior to analyses. The water of the beverage was used to make up the aqueous portion of the extraction solvent. Cocoa procyanidin quantitation was achieved through the use of a highly purified cocoa polyphenol extract. Samples were then compared as described in the Adamson et al. article to accurately determine the amounts of catechin, epicatechin, and procyanidin oligomers.

The following procedures were used for the preparation and testing of the high CP products.

### Preparation of Samples

In Example 1, the drinks were freeze dried and extracted twice with an acetone/water/acetic acid mixture (CH₂COCH₃:H₂O:HOAc, 79.5:20:0.51), sonicated for 15 min at 50° C., centrifuged for 6 min at 35000 rpm. The solvents were recovered from the collected supernatants under reduced pressure or under vacuum and freeze dried. The resulting material was used for the phase HPLC analysis. A total of 32-35 g of the cocoa beverage was quantitatively transferred to a 100 mL volumetric flask. To this was added 0.5 mL of glacial acetic acid and the solution was brought to volume with acetone.

In Examples 3 and 4, sample preparation for the cocoa drinks was modified to better accommodate the analysis of high moisture products. Sample preparation consisted of taking 32-35 grams of the drink and quantitatively transferring it to a 100 mL volumetric flask, adding 0.5 mL of glacial acetic acid, and adding acetone. This approach yields a solution that is comparable to the extraction solvent used on the other cocoa samples which consisted of 70:29.5:0.5-acetone:water:acetic acid (v/v/v). Drink samples were not defatted prior to analysis. The water of the drink was utilized to make up the aqueous portion of the extraction solvent.

Normal Phase Chromatography-HPLC/MS Analysis (Adamson et al. method)

For example 1, the published normal phase HPLC method of Adamson et al. (J. Agric. Food Chem., 1999, 47 pp. 4184-4186) was used. Conditions were as follows:

Stationary phase: Hypersil ODS 100×4.6 mm 5 μm particle size.

Mobile phase A: 0.170 HOAc in water.

Mobile phase B: 0.170 HOAc in methanol.

Flow rate: 1.0 mL/min

Gradient:

| Time (min) | % B |
|---|---|
| 0 | 15 |
| 20 | 25 |
| 30 | 75 |
| 45 | 100 |

The column used was a 250×4.6-mm, i.d., 5 μm Develosil diol (Phenomenex, Torrance, Calif.). The binary mobile phase consisted of (A) CH₃CN:HOAc, (98:2, v/v) and (B) CH₃OH:H₂O:HOAc (95:3:2). Separations were effected by a linear gradient at 30° C. with a 1.0 mL/min flow rate as follows: 0-35 min, 0-40% B; 35-45 min, 40% B isocratic; 45-46 min, 40-0% B, 4 min hold at 0% B. Eluent was monitored by fluorescence detection with excitation at 276 nm and emission at 316 nm.

The examples which follow are intended as an illustration of certain preferred embodiments of the invention, and no limitation of the invention is implied.

### EXAMPLES

### Example 1

Preparation of High CP Cocoa Solids from Cocoa Beans

Commercially available cocoa beans having an initial moisture content of about 7 to 8% by weight were pre-cleaned in a scalperator. The pre-cleaned beans from the scalperator were further cleaned in an air fluidized bed density separator. The cleaned cocoa beans were then passed through an infra-red heating apparatus at a rate of about 1,701 kilograms per hour. The depth of beans in the vibrating bed of the apparatus was about 2-3 beans deep. The surface temperature of the apparatus was set at about 165° C., thereby producing an internal bean temperature (IBT) of about 135° C. in a time ranging from 1 to 1.5 minutes. This treatment caused the shells to dry rapidly and separate from the cocoa nibs. The broken pieces separated by the vibrating screen prior to the apparatus were re-introduced into the product stream prior to the winnowing step. The resulting beans after micronizing should have a moisture content of about 3.9% by weight. The beans emerged at an IBT of about 135° C. and were immediately cooled to a temperature of about 90° C. in about three minutes to minimize additional moisture loss. The beans were then winnowed to crack the beans, to loosen the shells, and to separate the lighter shells from the nibs while at the same time minimizing the amount of nib lost with the shell reject stream. The resulting cocoa nibs were pressed using two screw presses to extract the butter from the cocoa solids.

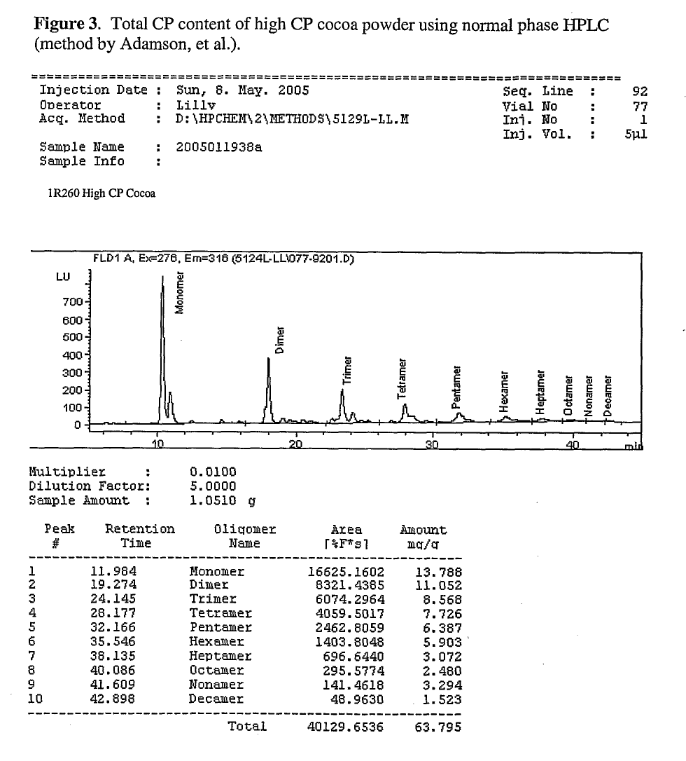

A sample of cocoa solids, produced according to the above-described process from unfermented cocoa beans (fermentation factor 233), when analyzed according to the above-referenced method, typically will have a total cocoa procyanidin content of about 50 to about 75, preferably about 60 to about 75, or more preferably about 75 to about 80 milligrams total cocoa procyanidins per gram of defatted cocoa powder FIG. 3 shows the normal phase HPLC trace of the high CP cocoa powder.

### Example 2

### Preparation of Cocoa Extracts

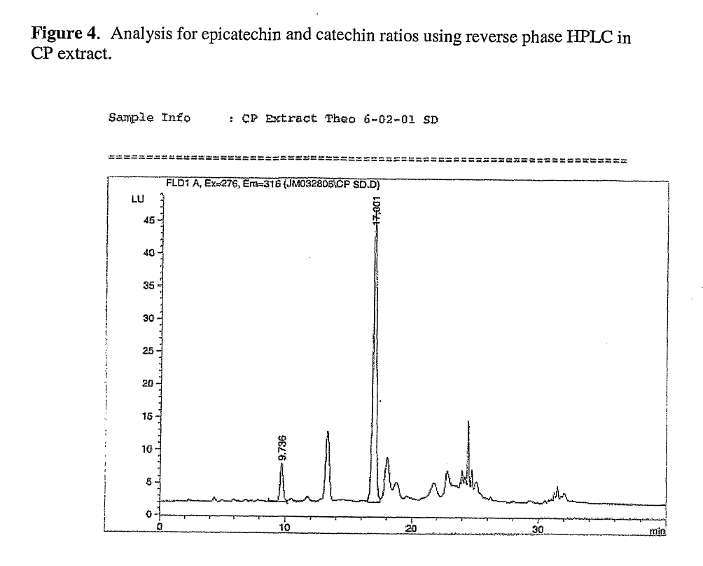

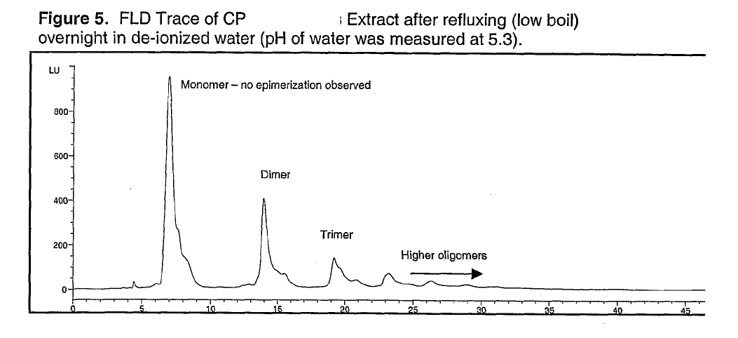

The cocoa solids from Example 1 were contacted at room temperature for from 0.5 to 2.5 hours with an aqueous organic solvent. For Cocoa Extract A the solvent was about 75% ethanol/25% water (v/v). For Cocoa Extract B the solvent was about 80% acetone/20% water (v/v). The micella was separated from the cocoa residue and concentrated by evaporation. The concentrated extract was then spray dried. The HPLC/FLD profiles of the cocoa extracts are shown. FIG. 4 shows the trace prior to heating. FIG. 5 shows the trace for the ethanol extract after refluxing overnight in deionized water after heating.

### Example 3

### Preparation of High CP Cocoa Beverages Containing Sterol Esters

Low fat cocoa beverages were prepared from milk, a high CP cocoa powder, a high CP cocoa extract, an alkalized cocoa powder, lecithin, Canola oil sterol esters, granulated sugar, a blend of cellulose and carrogeenan gums, a citrate/phosphate stabilizer blend, a vitamin-mineral premix and chocolate and vanilla flavors. 1% Milk was used. A recipe is set out in Table 1.

TABLE 1

| Ingredient | % W/W Range |
|---|---|
| water | 10-40 |
| low fat milk | 50-90 |
| granulated sugar | 5-10 |
| high CP cocoa powder | 0.5-3 |
| alkalized cocoa powder | 0.5-3 |
| high CP extract | 0.5-3 |
| Canola oil sterol esters | 0.2-1 |
| lecithin | 0.30 |
| cellulose | 0.35 |
| Carrageenan | 0.01-0.3 |
| phosphates | 01.-0.4 |
| vitamin-mineral mixture | 0.1-1.0 |
| cocoa flavor | 0.200 |
| natural flavors | 0.1-1.0 |
| Total | 100.00 |

The cocoa ingredients were slurried in water at 180° F. The remaining dry ingredients were mixed with 1% milk and added to the cocoa slurry. The pH was adjusted to 6.5-6.8 with citric acid. The cocoa beverage was packaged processed at 280° F. for 6.5 seconds.

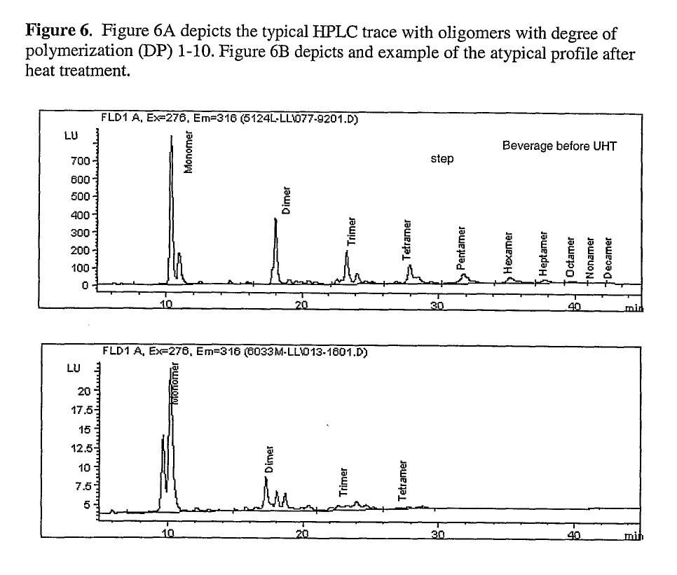

FIGS. 6A and B show the trace of a typical beverage before and after UHT treatment.

### Example 4

### Preparation of High CP Cocoa Beverages Containing no Sterol Esters

Two beverages were prepared from high CP cocoa solids and a high CP chocolate liquor but no high CP cocoa extract. The ingredients used are listing in Table 2 below.

TABLE 2

| Ingredient | Beverage A | Beverage B |
|---|---|---|
| 1% milk | 79.77 | 86.37 |
| granulated sugar | 9.50 | 9.50 |
| high CP cocoa powder | 2.20 | 2.20 |
| alkalized cocoa powder | 2.20 | 1.10 |
| chocolate liquor | 1.00 | 0.00 |
| cocoa crumb | 4.00 | 0.00 |
| malted milk powder | 0.5 | 0.00 |
| chocolate flavor | 0.20 | 0.20 |
| vanilla flavor | 0.25 | 0.25 |
| cellulose | 0.37 | 0.37 |
| carrageenan | 0.01 | 0.01 |
| Total | 100.00 | 100.00 |

Surprisingly, the beverages were less bitter and less astringent than expected given the high levels of cocoa polyphenols that they contained.

### Example 5

### Effect of Processing Variables

The effect of the processing variables on the loss of cocoa polyphenols (CPs) was studied. The CP content of the cocoa powder was 61.4 mg/g of defatted powder. The CP content of the extract was 384.99 mg/g of extract. The extract was a dried aqueous ethanol extract prepared from unfermented cocoa beans as described in Example 2. Percent loss was calculated based on post- and pre-process CP levels. The results are summarized in Table 3.

TABLE 3

| | Pre-process | Post-process | | | |
|---|---|---|---|---|---|
| Beverage | CP levels | CP levels | CP loss | CPs mg | |
| No. | (mg/g) (S1/S4) | (mg/g) (S5) | (%) | per serving | Test objectives & Comments |
| 1 | 1.40 | 1.06 | 24.3 | 229 | Test of aseptic process on CP |
| | | | | | w/o dairy proteins. (pH = 6.5) |
| 2 | 1.40 | 0.97 | 30.7 | 210 | Test of aseptic process on CP |
| | | | | | with dairy proteins. (pH = 6.5) |
| | | | | | non-fat dry milk |
| 3 | 1.40 | 0.71 | 49.3 | 153 | Conditions similar to No. 2 |
| | | | | | Alternate pH = 7.2 (typical |
| | | | | | chocolate dairy beverage) - |
| | | | | | reconstituted milk |
| 4 | 1.46 | 0.72 | 50.6 | 156 | Recipe No. 4 at pH 6.8 |
| 5 | 1.39 | 0.91 | 34.5 | 197 | Recipe No. 5 at pH 6.2 |

The results show that a 49.3% loss of CPs occurred at pH 7.2 whereas the loss at pH 6.5 was only 30.7%. In beverages 4 and 5 (both based on same recipe) the reduction in pH from 6.8 to 6.2 reduced the loss of CPs from 50.6% to 34.5%. FIGS. 6A and B are typical normal phase HPLC traces for the beverages before and after ultra-high temperature processing.

Other variations and modifications, which will be obvious to those skilled in the art, are within the scope and teachings of these inventions. The inventions are not to be limited except as set forth in the following claims.

1-31. (canceled)

32. An asceptically heat processed, milk-based, soy-based, or whey-based beverage containing at least about 0.6 milligrams of polyphenols per gram of the beverage and having a pH of about 4.8 to below about 6.8; wherein the polyphenols are flavan-3-ols selected from the group consisting of catechin, epicatechin, gallocatechin, epigallocatechin, afzelechin, and mixtures thereof and/or proanthocyanidins selected from the group consisting of procyanidins, prodelphinidins, propelargonidins, and mixtures thereof.

33. The beverage of claim 32, wherein the polyphenol content is up to 2.0 milligrams per gram of the beverage; wherein the flavan-3-ols are catechin and epicatechin; wherein the proanthocyanidins are procyanidins; wherein the pH is about 6.2 to about 6.8; and wherein the aseptic processing is vat pasteurization, high temperature, short time pasteurization, or ultra-high temperature sterilization.

34. The beverage of claim 33, wherein the procyanidins are cocoa procyanidin dimers, trimers, and tetramers.

35. An aseptically heat-processed, ready to drink cocoa beverage which comprises a milk, one or more cocoa ingredients having a high cocoa polyphenol content, and an edible acid; which beverage has a pH of about 4.8 to about 6.8; and which beverage contains about 0.2 to about 0.6 milligrams of cocoa polyphenols per gram of the beverage.

36. The cocoa beverage of claim 35, wherein the cocoa polyphenols comprise (±)-epicatechin, (±)-catechin, and procyanidin dimers, trimers, and tetramers thereof.

37. The cocoa beverage of claim 36, wherein the milk is a skim milk; wherein the cocoa ingredient(s) are a cocoa powder, a chocolate liquor, and/or a cocoa extract; and wherein the edible acid is citric acid.

38. The beverage of claim 37, wherein the cocoa powder contains at least about 25 milligrams of cocoa polyphenols per gram of the defatted cocoa powder; wherein the chocolate liquor contains at least about 10 milligrams of cocoa polyphenols per gram of the defatted chocolate liquor; and wherein the cocoa extract contains at least about 200 milligrams of cocoa polyphenols per gram of the dry cocoa extract.

39. The beverage of claim 38, wherein the cocoa powder contains about 25 to 50 about milligrams of cocoa polyphenols; wherein the chocolate liquor contains about 12 to about 25 milligrams of cocoa polyphenols; and wherein the cocoa extract contains about 250 to about 500 milligrams of cocoa polyphenols.

40. The beverage of claim 39, which further comprises an alkalized cocoa powder, an emulsifier, a nutritive carbohydrate sweetener and/or a sugar substitute, one or more thickeners, one or more stabilizers, and optionally a flavorant and vitamins and/or minerals mixture.

41. The beverage of claim 40, wherein the emulsifier is about 0.05 to about 5.0% of lecithin, a mono- or diglyceride, a phospholipid, an acetic, lactic, citric, succinic or tartaric acid ester of a monoglyceride, a fatty acid ester of a polyglycerol, a sorbitol ester, a sucrose ester, propylene glycol, or polyglycerol polyresorcinoleate; wherein the thickeners are up to 35% of a mixture of microcrystalline cellulose, carrageenan, and carboxymethylcellulose; wherein the stabilizers are about 0.2 to about 3% of a mixture of citrates and phosphates; wherein the flavorants are tip to 1% of chocolate or chocolate with vanilla, raspberry, blueberry, strawberry, banana, coffee, or mocha; and wherein the vitamins-mineral mixture is Up to 1% of vitamins B, C, and/or E and calcium, potassium, and/or magnesium.

42. The beverage of claim 40, which further comprises a sterol, a stanol, or a sterol and/or stanol ester, L-arginine, and/or an unsaturated fatty acid.

43. The beverage of claim 42, wherein the sterol ester is a Canola oil sterol ester; and wherein the unsaturated fatty acid is an omega-3 fatty acid.

44. An improved process for preparing a ready-to-eat or a ready-to-drink, aseptically heat-processed milk-based, soy-based, or whey-based product, wherein the improvement comprises the step of reducing the pH of the product by about 0.2 before heat processing the product.

45. The process of claim 44, wherein the edible polyphenols are flavan-3-ols and/or proanthocyanidins; wherein the pH of the product is reduced to about 4.8 to about 6.8; and wherein the heat processing is vat pasteurization, high temperature, short time pasteurization (HTST), or ultra-high temperature (UHT) sterilization.

46. The process of claim 44, wherein the product is a low fat cocoa beverage; wherein the flavan-3-ols are (±)-catechin and (±)-epicatechin; and wherein the proanthocyanidins are procyanidins.

47. A process for preparing a cocoa beverage containing at least about 0.2 milligrams of cocoa polyphenols per gram of the beverage, which process comprises the steps of:
(a) slurrying, under high shear, water and a dry cocoa mixture comprising a partially defatted cocoa powder having a cocoa polyphenol content of at least about 25 milligrams per gram of the defatted cocoa powder, a dry cocoa extract having a dry cocoa polyphenol content of at least about 200 milligrams of cocoa polyphenols per gram of the cocoa extract, and an alkalized cocoa powder;
(b) mixing a dry blend consisting essentially of a sweetener, one or more thickeners, one or more stabilizers, and/or a vitamin-mineral mixture into a milk
(c) adding the cocoa slurry from step (a) to the milk mixture from step (b);
(d) adding liquid flavorants;
(e) adding an edible acid to the mixture from step (d) to lower the pH by at least about 0.2;
(f) heat processing the slurry from step (e) for about 1 second to about 15 seconds at about 161° F. to about 270° F.;
(g) optionally cooling and/or homogenizing the slurry from step (f); and
(h) packaging the slurry from step (f) or step (g) as a ready-to-dink cocoa beverage.

48. The process of claim 47, wherein the beverage has a moisture content of at least about ⁵⁰% by weight; wherein the pH is lowered with citric acid; wherein the acidified mixture is heated for about 1 second to about 15 seconds at about 161° F. to about 280° F.; and wherein the pH of the packaged beverage is about 6.2 to about 6.8.

49. The process of claim 47, wherein the defatted cocoa powder and the dry cocoa extract are prepared from unfermented and/or underfermented cocoa beans; wherein the sweeteners are a nutritive carbohydrate sweetener and/or a sugar substitute; wherein the thickeners are gums; wherein the stabilizers are a citrate/phosphate blend; wherein the milk is a skim milk; and wherein the flavorants are chocolate or chocolate with vanilla, blueberry, raspberry, strawberry, banana, or mocha.

50. The process of claim 47, wherein the pH is lowered by at least about 0.4.

51. The process of claim 47 wherein the pH is lowered by 0.6.
